(19) United States
(12) Patent Application Publication
(10) Pub. No.: US 2025/0106661 A1
(43) Pub. Date: Mar. 27, 2025

(54) CONFIGURATION, MEASUREMENT, AND REPORTING FOR MULTIPLE WAVEFORM-BASED REFERENCE SIGNALS

(71) Applicant: Lenovo (Singapore) Pte. Ltd., New Tech Park (SG)

(72) Inventors: Ankit Bhamri, Rödermark (DE); Ali Ali, Kraiburg am Inn (DE); Sher Ali Cheema, Ilmenau (DE)

(21) Appl. No.: 18/290,936

(22) PCT Filed: Jul. 20, 2022
(86) PCT No.: PCT/IB2022/000419

§ 371 Date: Jan. 22, 2024

Related U.S. Application Data
(60) Provisional application No. 63/223,945, filed on Jul. 20, 2021.

(51) Int. Cl. H04W 24/10; H04L 5/00

(52) U.S. Cl. CPC H04W 24/10; H04L 5/0007; H04L 5/0094

(57) ABSTRACT

Apparatuses, methods, and systems are disclosed for configuration, measurement, and reporting for multiple wave-form-based reference signals. An apparatus (400) includes a transceiver (425) and a processor (405) that is coupled to the transceiver (425). The processor (405) is configured to cause the apparatus (400) to receive a first signaling information from a network, the first signaling information indicating a RS resource and a corresponding association to at least one waveform; receive a second signaling information from the network, the second signaling information indicating a reporting configuration for performing measurements on the RS resource and the corresponding at least one waveform; generate a measurement report according to the reporting configuration; and transmit the measurement report to the network.

### CROSS-REFERENCE TO OTHER APPLICATIONS

This application claims the benefit of United States Provisional Patent Application No. 63/223,945, entitled “MULTIPLE WAVEFORMS BASED RS CONFIGURATION/MEASUREMENTS/REPORTING AND BEAM FAILURE DETECTION/RECOVERY” and filed on Jul. 20, 2021, for Ankit Bhamri et al., which is incorporated herein by reference.

### FIELD

The subject matter disclosed herein relates generally to wireless communications and more particularly relates to configuration, measurement, and reporting for multiple waveform-based reference signals.

### BACKGROUND

One of the defining elements of any mobile communications system is the type of waveform used for the communication link in the radio access network for transmitting and receiving data.

### BRIEF SUMMARY

Disclosed are solutions for configuration, measurement, and reporting for multiple waveform-based reference signals. The solutions may be implemented by apparatus, systems, methods, or computer program products.

In one embodiment, a first apparatus includes a transceiver and a processor coupled to the transceiver. In one embodiment, the processor is configured to cause the apparatus to receive a first signaling information from a network, the first signaling information indicating a RS resource and a corresponding association to at least one waveform. In one embodiment, the processor is configured to cause the apparatus to receive a second signaling information from the network, the second signaling information indicating a reporting configuration for performing measurements on the RS resource and the corresponding at least one waveform. In one embodiment, the processor is configured to cause the apparatus to generate a measurement report according to the reporting configuration and transmit the measurement report to the network.

In one embodiment, a first method receives a first signaling information from a network, the first signaling information indicating a RS resource and a corresponding association to at least one waveform. In one embodiment, the first method receives a second signaling information from the network, the second signaling information indicating a reporting configuration for performing measurements on the RS resource and the corresponding at least one waveform. In one embodiment, the first method generates a measurement report according to the reporting configuration and transmits the measurement report to the network.

In one embodiment, a second apparatus includes a transceiver and a processor coupled to the transceiver. In one embodiment, the processor is configured to cause the apparatus to transmit a first signaling information to a UE, the first signaling information indicating a RS resource and a corresponding association to at least one waveform. In one embodiment, the processor is configured to cause the apparatus to transmit a second signaling information to the UE, the second signaling information indicating a reporting configuration for performing measurements on the RS resource and the corresponding at least one waveform. In one embodiment, the processor is configured to cause the apparatus to receive, from the UE, a measurement report generated according to the reporting configuration.

In one embodiment, a second method transmits a first signaling information to a UE, the first signaling information indicating a RS resource and a corresponding association to at least one waveform. In one embodiment, the second method transmits a second signaling information to the UE, the second signaling information indicating a reporting configuration for performing measurements on the RS resource and the corresponding at least one waveform. In one embodiment, the second method receives, from the UE, a measurement report generated according to the reporting configuration.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for configuration, measurement, and reporting for multiple waveform-based reference signals;

FIG. 2 is a diagram illustrating one embodiment of a new radio (“NR”) protocol stack;

FIG. 3A is one example of a Waveform Specific CSI-ResourceConfig information element;

FIG. 3B is one example of another Waveform Specific CSI-ResourceConfig information element;

FIG. 4 is a block diagram illustrating one embodiment of a user equipment apparatus that may be used for configuration, measurement, and reporting for multiple waveform-based reference signals;

FIG. 5 is a block diagram illustrating one embodiment of a network apparatus that may be used for configuration, measurement, and reporting for multiple waveform-based reference signals;

FIG. 6 is a flowchart diagram illustrating one embodiment of a method for configuration, measurement, and reporting for multiple waveform-based reference signals; and

FIG. 7 is a flowchart diagram illustrating one embodiment of another method for configuration, measurement, and reporting for multiple waveform-based reference signals.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for configuration, measurement, and reporting for multiple waveform-based reference signals. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

In Rel-19 or beyond, it is expected that new additional waveforms will be considered for NR operation beyond 71 GHz. For downlink (“DL”), currently only cyclic prefix-orthogonal frequency division multiplexing (“CP-OFDM”) is supported. Any new waveform such a Discrete Fourier Transform spread OFDM (“DFT-s-OFDM”), single carrier-frequency domain equalization (“SC-FDE”), SC-quadrature amplitude modulation (“SC-QAM”), or some other single carrier waveform is expected to be specified for 5G-Advanced in addition to CP-OFDM. This may impact how the measurements and reporting are done for different waveforms.

Currently, there are no waveform-specific measurements and reporting for determining beam, channel, and/or link quality. For example, if a measurement is done on a reference signal (“RS”) for an OFDM-based waveform, it is not expected that such measurement could be useful to determine the beam/channel/link quality for a single carrier waveform or vice-versa as each waveform can be impacted by the channel differently. Therefore, in this disclosure, solutions are disclosed to deal with the following aspects:
RS (e.g., channel state information-RS (“CSI-RS”), sounding reference signal (“SRS”), synchronization signal block (“SSB”), demodulation RS (“DM-RS”)) configuration, measurement, and reporting enhancements for multi-waveform DL and/or UL. Enhanced RS resource configuration and corresponding measurement/reporting configuration is proposed to allow waveform specific measurements and reporting such that the network can make informed decision on which waveform is suitable under what channel conditions. In one embodiment, the proposed solution measures how specific waveforms perform under certain conditions and not have waveform agnostic measurements; and
Beam failure detection and recovery enhancements for multi-waveform DL and/or UL. Enhanced beam/radio failure detection and recovery is proposed when multiple waveforms can be supported to provide an additional dimension before beam/radio link failure is declared and recovery procedure is initiated. The failure of a particular beam/radio link can also depend on which waveform is used for transmission/reception. Therefore, in one embodiment, the proposed solution considers different waveform measurements before initiating the beam recovery procedure. In other words, it increases the possibility of reducing the beam failure detection and recovery.

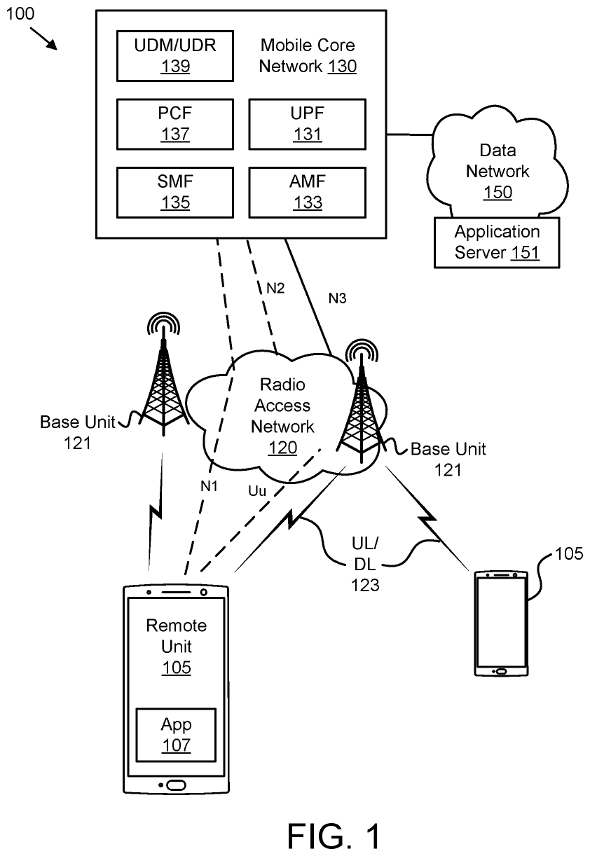

FIG. 1 depicts a wireless communication system 100 supporting CSI enhancements for higher frequencies, according to embodiments of the disclosure. In one embodiment, the wireless communication system 100 includes at least one remote unit 105, a radio access network (“RAN”) 120, and a mobile core network 130. The RAN 120 and the mobile core network 130 form a mobile communication network. The RAN 120 may be composed of a base unit 121 with which the remote unit 105 communicates using wireless communication links 115. Even though a specific number of remote units 105, base units 121, wireless communication links 115, RANs 120, and mobile core networks 130 are depicted in FIG. 1, one of skill in the art will recognize that any number of remote units 105, base units 121, wireless communication links 115, RANs 120, and mobile core networks 130 may be included in the wireless communication system 100.

In one implementation, the RAN 120 is compliant with the 5G system specified in the Third Generation Partnership Project (“3GPP”) specifications. For example, the RAN 120 may be a New Generation Radio Access Network (“NG-RAN”), implementing NR RAT and/or 3GPP Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 130.

In some embodiments, the remote units 105 communicate with an application server via a network connection with the mobile core network 130. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 130 via the RAN 120. The mobile core network 130 then relays traffic between the remote unit 105 and the application server (e.g., the content server 151 in the packet data network 150) using the PDU session. The PDU session represents a logical connection between the remote unit 105 and the User Plane Function (“UPF”) 131.

In order to establish the PDU session (or PDN connection), the remote unit 105 must be registered with the mobile core network 130 (also referred to as “attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5GS”), the term “PDU Session” a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR-U operation, the base unit 121 and the remote unit 105 communicate over unlicensed radio spectrum.

In one embodiment, the mobile core network 130 is a 5GC or an Evolved Packet Core (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an Access and Mobility Management Function (“AMF”) 133 that serves the RAN 120, a Session Management Function (“SMF”) 135, a Network Exposure Function (“NEF”), a Policy Control Function (“PCF”) 137, a Unified Data Management function (“UDM”) and a User Data Repository (“UDR”) 139.

The UPF(s) 131 is responsible for packet routing and forwarding, packet inspection, QoS handling, and external PDU session for interconnecting Data Network (“DN”), in the 5G architecture. The AMF 133 is responsible for termination of NAS signaling, NAS ciphering & integrity protection, registration management, connection management, mobility management, access authentication and authorization, security context management. The SMF 135 is responsible for session management (i.e., session establishment, modification, release), remote unit (i.e., UE) IP address allocation & management, DL data notification, and traffic steering configuration for UPF for proper traffic routing.

The NEF 136 is responsible for making network data and resources easily accessible to customers and network partners. Service providers may activate new capabilities and expose them through APIs. These APIs allow third-party authorized applications to monitor and configure the network's behavior for a number of different subscribers (i.e., connected devices with different applications). The PCF 137 is responsible for unified policy framework, providing policy rules to CP functions, access subscription information for policy decisions in UDR.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting of the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

While FIG. 1 depicts components of a 5G RAN and a 5G core network, the described embodiments apply to other types of communication networks and RATs, including IEEE 802.11 variants, Global System for Mobile Communications (“GSM”, i.e., a 2G digital cellular network), General Packet Radio Service (“GPRS”), UMTS, LTE variants, CDMA 2000, Bluetooth, ZigBee, Sigfox, and the like.

In the following descriptions, the term “gNB” is used for the base station but it is replaceable by any other radio access node, e.g., RAN node, eNB, Base Station (“BS”), Access Point (“AP”), NR, etc. Further the operations are described mainly in the context of 5G NR. However, the proposed solutions/methods are also equally applicable to other mobile communication systems supporting CSI enhancements for higher frequencies.

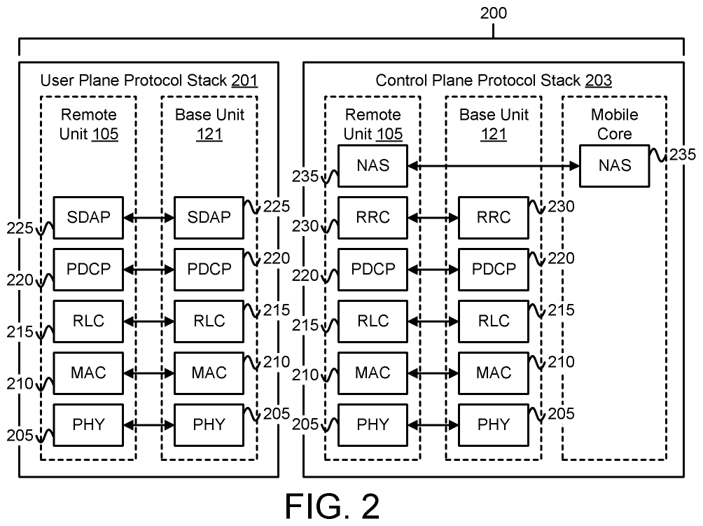

FIG. 2 depicts a NR protocol stack 200, according to embodiments of the disclosure. While FIG. 2 shows the remote unit 105, the base unit 121 and the mobile core network 130, these are representative of a set of UEs interacting with a RAN node and a NF (e.g., AMF) in a core network. As depicted, the protocol stack 200 comprises a User Plane protocol stack 201 and a Control Plane protocol stack 203. The User Plane protocol stack 201 includes a physical (“PHY”) layer 205, a Medium Access Control (“MAC”) sublayer 210, a Radio Link Control (“RLC”) sublayer 215, a Packet Data Convergence Protocol (“PDCP”) sublayer 220, and a Service Data Adaptation Protocol (“SDAP”) layer 225. The Control Plane protocol stack 203 also includes a physical layer 205, a MAC sublayer 210, an RLC sublayer 215, and a PDCP sublayer 220. The Control Place protocol stack 203 also includes a Radio Resource Control (“RRC”) sublayer 230 and a Non-Access Stratum (“NAS”) sublayer 235.

The AS protocol stack for the Control Plane protocol stack 203 consists of at least RRC, PDCP, RLC and MAC sublayers, and the physical layer. The AS protocol stack for the User Plane protocol stack 201 consists of at least SDAP, PDCP, RLC and MAC sublayers, and the physical layer. The Layer-2 (“L2”) is split into the SDAP, PDCP, RLC and MAC sublayers. The Layer-3 (“L3”) includes the RRC sublayer 230 and the NAS layer 235 for the control plane and includes, e.g., an Internet Protocol (“IP”) layer or PDU Layer (note depicted) for the user plane. L1 and L2 are referred to as “lower layers” such as PUCCH/PUSCH or MAC CE, while L3 and above (e.g., transport layer, application layer) are referred to as “higher layers” or “upper layers” such as RRC.

The physical layer 205 offers transport channels to the MAC sublayer 210. The MAC sublayer 210 offers logical channels to the RLC sublayer 215. The RLC sublayer 215 offers RLC channels to the PDCP sublayer 220. The PDCP sublayer 220 offers radio bearers to the SDAP sublayer 225 and/or RRC sublayer 230. The SDAP sublayer 225 offers QoS flows to the mobile core network 130 (e.g., 5GC). The RRC sublayer 230 provides for the addition, modification, and release of Carrier Aggregation and/or Dual Connectivity. The RRC sublayer 230 also manages the establishment, configuration, maintenance, and release of Signaling Radio Bearers (“SRBs”) and Data Radio Bearers (“DRBs”). In certain embodiments, an RRC entity functions for detection of and recovery from radio link failure.

As background, regarding multiple waveform support for UL in NR, in NR Rel. 15 UL, multiple waveforms are supported. gNB switches between multicarrier CP-OFDM and single carrier DFT-s-OFDM via radio resource control (“RRC”) configurations. The higher layer parameter transformPrecoder in pusch-Config/configuredGrantConfig or msg3-transformPrecoderin RACH-ConfigCommon provide the indication to enable or disable the transform pre-coder for physical uplink shared channel (“PUSCH”). The UE shall consider the transform precoding either ‘enabled’ or ‘disabled’ based on reading these messages, and the gNB applies simultaneous receptions of multiple UEs with different waveforms. Furthermore, switching between DFT-s-OFDM PUCCH, or other types of PUCCH waveforms, is indicated by the PUCCH format.

Regarding CSI framework in NR, currently in NR, the CSI framework and reporting procedure is not specified according to a specific waveform since only CP-OFDM-based DL is supported. According to clause 5.2.1 in 3GPP TS 38.214 V16.4.0, CSI framework is defined as follows:

The procedures on aperiodic CSI reporting described in this clause assume that the CSI reporting is triggered by DCI format 0_1, but they equally apply to CSI reporting triggered by DCI format 0_2, by applying the higher layer parameter reportTriggerSizeDCI-0-2 instead of reportTriggerSize.

The time and frequency resources that can be used by the UE to report CSI are controlled by the gNB. CSI may consist of Channel Quality Indicator (“CQI”), precoding matrix indicator (“PMI”), CSI-RS resource indicator (“CRI”), SS/PBCH Block Resource indicator (“SSBRI”), layer indicator (“L1”), rank indicator (“RI”), L1-reference signal received power (“RSRP”) or L1-signal to interference noise ratio (“SINR”).

For CQI, PMI, CRI, SSBRI, L1, RI, L1-RSRP, L1-SINR a UE is configured by higher layers with N≥1 CSI-ReportConfig Reporting Settings, M≥1 CSI-ResourceConfig Resource Settings, and one or two list(s) of trigger states (given by the higher layer parameters CSI-AperiodicTriggerStateList and CSI-SemiPersistentOnPUSCH-TriggerStateList). Each trigger state in CSI-AperiodicTriggerStateList contains a list of associated CSI-ReportConfigs indicating the Resource Set IDs for channel and optionally for interference. Each trigger state in CSI-SemiPersistentOnPUSCH-TriggerStateList contains one associated CSI-ReportConfig.

Each Reporting Setting CSI-ReportConfig is associated with a single downlink bandwidth part (“BWP”) (indicated by higher layer parameter BWP-Id) given in the associated CSI-ResourceConfig for channel measurement and contains the parameter(s) for one CSI reporting band: codebook configuration including codebook subset restriction, time-domain behavior, frequency granularity for CQI and PMI, measurement restriction configurations, and the CSI-related quantities to be reported by the UE such as the layer indicator (L1), L1-RSRP, L1-SINR, CRI, and SSBRI (SSB Resource Indicator).

The time domain behavior of the CSI-ReportConfig is indicated by the higher layer parameter reportConfigType and can be set to ‘aperiodic’, ‘semiPersistentOnPUCCH’, ‘semiPersistentOnPUSCH’, or ‘periodic’. For ‘periodic’ and ‘semiPersistentOnPUCCH’/‘semiPersistentOnPUSCH’ CSI reporting, the configured periodicity and slot offset applies in the numerology of the UL BWP in which the CSI report is configured to be transmitted on. The higher layer parameter reportQuantity indicates the CSI-related, L1-RSRP-related or L1-SINR-related quantities to report. The reportFreqConfiguration indicates the reporting granularity in the frequency domain, including the CSI reporting band and if PMI/CQI reporting is wideband or sub-band. The timeRestrictionForChannelMeasurements parameter in CSI-ReportConfig can be configured to enable time domain restriction for channel measurements and timeRestrictionForInterferenceMeasurements can be configured to enable time domain restriction: for interference measurements. The CSI-ReportConfig can also contain CodebookConfig, which contains configuration parameters for Type-I, Type II or Enhanced Type II CSI including codebook subset restriction, and configurations of group-based reporting.

Each CSI Resource Setting CSI-ResourceConfig contains a configuration of a list of S≥1 CSI Resource Sets (given by higher layer parameter csi-RS-ResourceSetList), where the list is comprised of references to either or both of non-zero power (“NZP”) CSI-RS resource set(s) and SS/PBCH block set(s) or the list is comprised of references to CSI-interference measurement (“IM”) resource set(s). Each CSI Resource Setting is located in the DL BWP identified by the higher layer parameter BWP-id, and all CSI Resource Settings linked to a CSI Report Setting have the same DL BWP.

The time domain behavior of the CSI-RS resources within a CSI Resource Setting are indicated by the higher layer parameter resourceType and can be set to aperiodic, periodic, or semi-persistent. For periodic and semi-persistent CSI Resource Settings, the number of CSI-RS Resource Sets configured is limited to S=1. For periodic and semi-persistent CSI Resource Settings, the configured periodicity and slot offset is given in the numerology of its associated DL BWP, as given by BWP-id. When a UE is configured with multiple CSI-ResourceConfigs consisting of the same NZP CSI-RS resource ID, the same time domain behavior shall be configured for the CSI-ResourceConfigs. When a UE is configured with multiple CSI-ResourceConfigs consisting of the same CSI-IM resource ID, the same time-domain behavior shall be configured for the CSI-ResourceConfigs. All CSI Resource Settings linked to a CSI Report Setting shall have the same time domain behavior.

The following are configured via higher layer signaling for one or more CSI Resource Settings for channel and interference measurement:
CSI-IM resource for interference measurement, e.g., as described in Clause 5.2.2.4.
NZP CSI-RS resource for interference measurement, e.g., as described in Clause 5.2.2.3.1.
NZP CSI-RS resource for channel measurement, e.g., as described in Clause 5.2.2.3.1.

The UE may assume that the NZP CSI-RS resource(s) for channel measurement and the CSI-IM resource(s) for interference measurement configured for one CSI reporting are resource-wise QCLed with respect to ‘typeD’. When NZP CSI-RS resource(s) is used for interference measurement, the UE may assume that the NZP CSI-RS resource for channel measurement and the CSI-IM resource or NZP CSI-RS resource(s) for interference measurement configured for one CSI reporting are QCLed with respect to ‘typeD’.

For L1-SINR measurement:
When one Resource Setting is configured, the Resource Setting (given by higher layer parameter resourcesForChannelMeasurement) is for channel and interference measurement on NZP CSI-RS for L1-SINR computation. UE may assume that same 1 port NZP CSI-RS resource(s) with density 3 REs/RB is used for both channel and interference measurements.
When two Resource Settings are configured, the first one Resource Setting (given by higher layer parameter resourcesForChannelMeasurement) is for channel measurement on synchronization signal block (“SSB”) or NZP CSI-RS and the second one (given by either higher layer parameter csi-IM-Resources ForInterference or higher layer parameter nzp-CSI-RS-ResourcesForInterference) is for interference measurement performed on CSI-IM or on 1 port NZP CSI-RS with density 3 resource elements (“REs”)/resource blocks (“RBs”), where each SSB or NZP CSI-RS resource for channel measurement is associated with one CSI-IM resource or one NZP CSI-RS resource for interference measurement by the ordering of the SSB or NZP CSI-RS resource for channel measurement and CSI-IM resource or NZP CSI-RS resource for interference measurement in the corresponding resource sets. The number of SSB(s) or CSI-RS resources for channel measurement equals to the number of CSI-IM resources or the number of NZP CSI-RS resource for interference measurement.
UE may apply the SSB, or ‘typeD’ RS configured with qcl-Type set to ‘typeD’ to the NZP CSI-RS resource for channel measurement, as the reference RS for determining ‘typeD’ assumption for the corresponding CSI-IM resource or the corresponding NZP CSI-RS resource for interference measurement configured for one CSI reporting.
UE may expect that the NZP CSI-RS resource set for channel measurement and the NZP-CSI-RS resource set for interference measurement, if any, are configured with the higher layer parameter repetition.

Regarding beam failure detection and recovery procedure in NR, according to section 5.17 of 3GPP TS 38.321, beam failure detection and recovery procedure in NR is specified as follows:

The MAC entity may be configured by RRC per Serving Cell with a beam failure recovery procedure which is used for indicating to the serving gNB of a new SSB or CSI-RS when beam failure is detected on the serving SSB(s)/CSI-RS(s). Beam failure is detected by counting beam failure instance indication from the lower layers to the MAC entity. If beamFailureRecoveryConfig is reconfigured by upper layers during an ongoing Random Access procedure for beam failure recovery for SpCell, the MAC entity shall stop the ongoing Random Access procedure and initiate a Random Access procedure using the new configuration.

RRC is used to configure the following parameters in the BeamFailureRecoveryConfig, BeamFailureRecoverySCellConfig, and the RadioLinkMonitoringConfig for the Beam Failure Detection and Recovery procedure:
beamFailureInstanceMaxCount for the beam failure detection;
beamFailureDetectionTimer for the beam failure detection;
beamFailureRecoveryTimer for the beam failure recovery procedure;
rsrp-ThresholdSSB: an RSRP threshold for the SpCell beam failure recovery (“BFR”);
rsrp-ThresholdBFR: an RSRP threshold for the SCell beam failure recovery;
power RampingStep: powerRampingStep for the SpCell beam failure recovery;
powerRampingStepHighPriority: powerRampingStepHighPriority for the SpCell beam failure recovery;
preambleReceivedTargetPower: preambleReceivedTargetPower for the SpCell beam failure recovery;
preambleTransMax: preambleTransMax for the SpCell beam failure recovery;
scalingFactorBI: scalingFactorBI for the SpCell beam failure recovery;
ssb-perRACH-Occasion: ssb-perRACH-Occasion for the SpCell beam failure recovery using contention-free Random Access Resources;
ra-ResponseWindow: the time window to monitor response(s) for the SpCell beam failure recovery using contention-free Random Access Resources;
prach-ConfigurationIndex: prach-ConfigurationIndex for the SpCell beam failure recovery using contention-free Random Access Resources;
ra-ssb-OccasionMaskIndex: ra-ssb-OccasionMaskIndex for the SpCell beam failure recovery using contention-free Random Access Resources;
ra-OccasionList: ra-OccasionList for the SpCell beam failure recovery using contention-free Random Access Resources;
candidateBeamRSList: list of candidate beams for SpCell beam failure recovery;
candidateBeamRSSCellList: list of candidate beams for SCell beam failure recovery.

The following UE variables are used for the beam failure detection procedure:
BFI_COUNTER (per Serving Cell): counter for beam failure instance (“BFI”) indication which is initially set to 0.

The MAC entity shall for each Serving Cell configured for beam failure detection:
1> if beam failure instance indication has been received from lower layers:
   2> start or restart the beamFailureDetectionTimer;
   2> increment BFI_COUNTER by 1;
   2> if BFI_COUNTER>=beamFailureInstanceMaxCount:
      3> if the Serving Cell is SCell:
         4> trigger a BFR for this Serving Cell;
      3> else:
         4> initiate a Random Access procedure (see clause 5.1) on the SpCell.
1> if the beamFailureDetectionTimer expires; or
1> if beamFailureDetectionTimer, beamFailureInstanceMaxCount, or any of the reference signals used for beam failure detection is reconfigured by upper layers associated with this Serving Cell:
   2> set BFI_COUNTER to 0.
1> if the Serving Cell is SpCell and the Random Access procedure initiated for SpCell beam failure recovery is successfully completed (see clause 5.1):
   2> set BFI_COUNTER to 0;
   2> stop the beamFailureRecovery Timer, if configured;
   2> consider the Beam Failure Recovery procedure successfully completed.
1> else if the Serving Cell is SCell, and a physical downlink control channel (“PDCCH”) addressed to C-RNTI indicating uplink grant for a new transmission is received for the HARQ process used for the transmission of the BFR MAC CE or Truncated BFR MAC CE which contains beam failure recovery information of this Serving Cell; or
1> if the SCell is deactivated as specified in clause 5.9:
   2> set BFI_COUNTER to 0;
   2> consider the Beam Failure Recovery procedure successfully completed and cancel all the triggered BFRs for this Serving Cell.

The MAC entity shall:
1> if the Beam Failure Recovery procedure determines that at least one BFR has been triggered and not cancelled for an SCell for which evaluation of the candidate beams according to the requirements as specified in TS 38.133 has been completed:
   2> if UL-SCH resources are available for a new transmission and if the UL-SCH resources can accommodate the BFR MAC CE plus its subheader as a result of LCP:
      3> instruct the Multiplexing and Assembly procedure to generate the BFR MAC CE.
   2> else if UL-SCH resources are available for a new transmission and if the UL-SCH resources can accommodate the Truncated BFR MAC CE plus its subheader as a result of LCP:
      3> instruct the Multiplexing and Assembly procedure to generate the Truncated BFR MAC CE.
   2> else:
      3> trigger the SR for SCell beam failure recovery for each SCell for which BFR has been triggered, not cancelled, and for which evaluation of the candidate beams according to the requirements as specified in TS 38.133 has been completed.

All BFRs triggered for an SCell shall be cancelled when a MAC PDU is transmitted and this PDU includes a BFR MAC CE or Truncated BFR MAC CE which contains beam failure information of that SCell. Further details related to link recovery procedures are specified in section 6 of 3GPP TS 38.213 as follows:

A UE can be provided, for each BWP of a serving cell, a set q̅₀̅ of periodic CSI-RS resource configuration indexes by failureDetectionResources and a set q̅₁̅ of periodic CSI-RS resource configuration indexes and/or SS/PBCH block indexes by candidateBeamRSList for radio link quality measurements on the BWP of the serving cell. If the UE is not provided failureDetectionResources, the UE determines the set q̅₀̅ to include periodic CSI-RS resource configuration indexes with same values as the RS indexes in the RS sets indicated by TCI-State for respective control resource sets (“CORESETs”) that the UE uses for monitoring PDCCH and, if there are two RS indexes in a transmission configuration indicator (“TCI”) state, the set q̅₀̅ includes RS indexes with QCL-TypeD configuration for the corresponding TCI states. The UE expects the set q̅₀̅ to include up to two RS indexes. The UE expects single port RS in the set q̅₀̅.

The thresholds Q_{out,LR} and Q_{in,LR} correspond to the default value of rlmInSyncOutOfSyncThreshold, e.g., as described in TS 38.133 for Qₒᵤₜ, and to the value provided by rsrp-ThresholdSSB, respectively.

The physical layer in the UE assesses the radio link quality according to the set q̅₀̅ of resource configurations against the threshold Q_{out,LR}. For the set q̅₀̅, the UE assesses the radio link quality only according to periodic CSI-RS resource configurations or SS/PBCH blocks that are quasi co-located, e.g., as described in TS 38.214, with the DM-RS of PDCCH receptions monitored by the UE. The UE applies the Q_{in,LR} threshold to the L1-RSRP measurement obtained from a SS/PBCH block. The UE applies the Q_{in,LR} threshold to the L1-RSRP measurement obtained for a CSI-RS resource after scaling a respective CSI-RS reception power with a value provided by powerControlOffsetSS.

In non-discontinuous reception (“DRX”) mode operation, the physical layer in the UE provides an indication to higher layers when the radio link quality for all corresponding resource configurations in the set q̅₀̅ that the UE uses to assess the radio link quality is worse than the threshold Q_{out,LR}. The physical layer informs the higher layers when the radio link quality is worse than the threshold Q_{out,LR} with a periodicity determined by the maximum between the shortest periodicity among the periodic CSI-RS configurations and/or SS/PBCH blocks in the set q̅₀̅ that the UE uses to assess the radio link quality and 2 msec. In DRX mode operation, the physical layer provides an indication to higher layers when the radio link quality is worse than the threshold Q_{out,LR} with a periodicity determined, e.g., as described in TS 38.133.

Upon request from higher layers, the UE provides to higher layers the periodic CSI-RS configuration indexes and/or SS/PBCH block indexes from the set q̅₁̅ and the corresponding L1-RSRP measurements that are larger than or equal to the Q_{in,LR} threshold.

A UE can be provided a CORESET through a link to a search space set provided by recoverySearchSpaceId, e.g., as described in Clause 10.1, for monitoring PDCCH in the CORESET. If the UE is provided recoverySearchSpaceId, the UE does not expect to be provided another search space set for monitoring PDCCH in the CORESET associated with the search space set provided by recoverySearchSpaceId.

The UE may receive by PRACH-ResourceDedicatedBFR, a configuration for physical random access channel (“PRACH”) transmission, e.g., as described in Clause 8.1. For PRACH transmission in slot K and according to antenna port quasi co-location parameters associated with periodic CSI-RS resource configuration or with SS/PBCH block associated with index Anew provided by higher layers, e.g., as described in TS 38.321, the UE monitors PDCCH in a search space set provided by recoverySearchSpaceId for detection of a DCI format with cyclic redundancy check (“CRC”) scrambled by cell radio network temporary identifier (“C-RNTI”) or modulation coding scheme (“MCS”)-C-RNTI starting from slot n+4 within a window configured by BeamFailureRecoveryConfig. For PDCCH monitoring in a search space set provided by recoverySearchSpaceId and for corresponding PDSCH reception, the UE assumes the same antenna port quasi-collocation parameters as the ones associated with index q_{new} until the UE receives by higher layers an activation for a TCI state or any of the parameters tci-StatesPDCCH-ToAddList and/or tci-StatesPDCCH-ToReleaseList. After the UE detects a DCI format with CRC scrambled by C-RNTI or MCS-C-RNTI in the search space set provided by recoverySearchSpaceId, the UE continues to monitor PDCCH candidates in the search space set provided by recoverySearchSpaceId until the UE receives a MAC CE activation command for a TCI state or tci-StatesPDCCH-ToAddList and/or tci-StatesPDCCH-ToReleaseList.

After 28 symbols from a last symbol of a first PDCCH reception in a search space set provided by recoverySearchSpaceId for which the UE detects a DCI format with CRC scrambled by C-RNTI or MCS-C-RNTI and until the UE receives an activation command for PUCCH-SpatialRelationInfo, e.g., as described in TS 38.321, or is provided PUCCH-SpatialRelationInfo for PUCCH resource(s), the UE transmits a PUCCH on a same cell as the PRACH transmission using
a same spatial filter as for the last PRACH transmission
a power determined, e.g., as described in Clause 7.2.1, with qᵤ=0, q_{d}=q_{new}, and l=0

After 28 symbols from a last symbol of a first PDCCH reception in a search space set provided by recoverySearchSpaceId where a UE detects a DCI format with CRC scrambled by C-RNTI or MCS-C-RNTI, the UE assumes the same antenna port quasi-collocation parameters as the ones associated with index q_{new} for PDCCH monitoring in a CORESET with index 0.

According to a first embodiment directed to waveform associated RS configuration, measurements, and reporting enhancements, when multiple waveforms can be supported for DL and/or UL, the RS resource configuration is proposed to be associated with specific waveform types either implicitly or in an explicit manner to allow corresponding waveform specific measurements.

In this manner, this will allow to measure and report channel, radio link, and beam measurements specific to waveform and consequently the network can select the suitable waveform and corresponding transmission/reception parameters. Otherwise, it is not possible to correctly determine the channel, radio link, and beam quality for one waveform based on the measurements done on another waveform when the waveforms belong to different categories such as single carrier or multi-carrier waveform.

In one embodiment directed to waveform-specific RS resource configuration, each of the RS resources configured to the UE can be associated with a waveform either via explicit indication/configuration or implicit association. In one implementation, the RRC configuration is enhanced to explicitly associate at least one waveform to receive/transmit the RS by the UE. The RS configuration can be CSI-RS resource configuration, SRS resource configuration, SSB RS resource configuration, or the like.

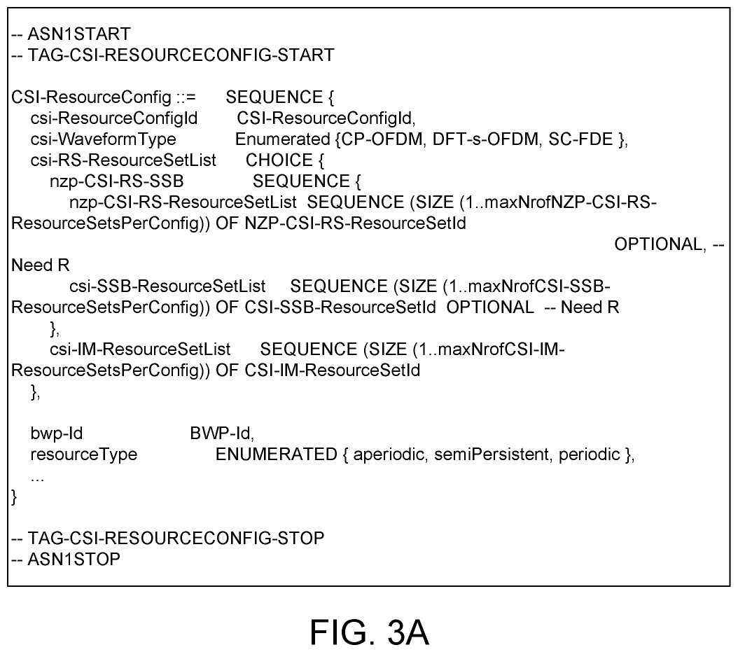

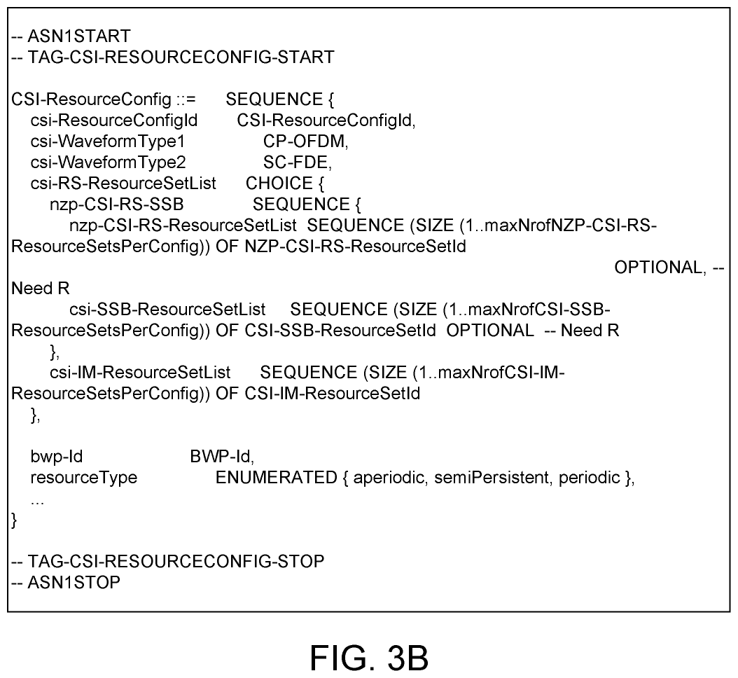

An illustration of RRC configuration for CSI-RS resources with waveform association enhancements is shown in FIG. 3A-Waveform Specific CSI-ResourceConfig information element. It is noted that the options for waveform types are just an example. It is applicable with other waveforms as well.

In another implementation, the RRC configuration for RS resources may or may not be configured with waveform association; however, the waveform association for the RS resource is indicated/updated via MAC CE, DCI, or a combination thereof. For aperiodic and semi-persistent RS resources, such indication of waveform can be signaled along with the trigger/activation command. In another implementation, an explicit indication in the DCI/MAC can be signaled to apply the waveform for transmission/receptions in the scheduled slots.

In some embodiments, depending up on the waveform indicated/updated by MAC CE and/or DCI, it is expected that the associated RS resource configuration can support corresponding RS configurations. For example, if CP-OFDM is indicated/updated by MAC CE and/or DCI, then the UE is expected to apply multi-carrier-based RS pattern/configuration (that is pre-configured or semi-statically signaled). Similarly, if single carrier waveform like SC-FDE is indicated/updated by MAC CE and/or DCI, then UE is expected to apply single-carrier based RS pattern/configuration (that is pre-configured or semi-statically signaled).

According to another embodiment directed to multi-waveform associated RS resource configuration, each of the RS resource configured to the UE can be associated with multiple waveforms either via explicit indication/configuration or implicit association. In one implementation, the RRC configuration is enhanced to explicitly associate at least two waveforms to receive/transmit the RS by the UE. The RS configuration can be a CSI-RS resource configuration, an SRS resource configuration, an SSB RS resource configuration, or the like. An illustration of RRC configuration for CSI-RS resource with multiple waveform association enhancements is shown in FIG. 3B—Waveform Specific CSI-ResourceConfig information element.

In one implementation, when one RS resource is associated with a multiple waveform type, then the RS resource is transmitted/repeated with the multiple waveform type. For periodic and semi-persistent RS, different repetition patterns across different periods can be pre-configured or semi-statically configured or dynamically indicated on which waveform to apply in which period. In an alternate implementation, the UE is expected to apply only one of the multiple waveforms configured. The exact waveform to apply can be either explicitly indicated by the network or implicitly derived based on other transmission's waveform in the same transmission time interval (“TTI”). Explicit selection of waveform for semi-persistent and/or periodic RS can be indicated along with activation/triggering command.

According to another embodiment directed to enhanced measurements and reporting with multiple waveform support, the UE is configured to measure beam, channel quality, radio link, or some combination thereof on one or multiple waveforms and is configured to report corresponding measurements for each of the multiple waveforms. In one implementation, the UE is configured to report measurements on at least one of the RS resource indicators associated with a single carrier waveform (such as SC-FDE) and another measurement on at least one of the RS resource indicators associated with a multi-carrier waveform (such as CP-OFDM).

In an alternate embodiment, the UE is configured to measure beam, channel quality, radio link, or some combination thereof on at least two waveforms and is configured to report corresponding measurements for only one of the multiple waveforms, where the beam quality, channel quality, and/or radio link quality is better than the other waveforms.

In an alternate embodiment, the UE is configured to measure beam, channel quality, radio link, or some combination thereof on at least two waveforms and is configured to report corresponding measurements that indicate which waveforms have beam quality, channel quality, and/or radio link quality that is less than a pre-defined threshold for each waveform to indicate discarding these waveforms for the next transmission.

In some embodiments, when multiple waveforms can be associated with an RS resource (such as a CSI-RS resource), where the UE is required to perform measurements using the multiple waveforms, then the reporting quantities are enhanced to also indicate the waveform type along with other quantities. Reporting quantities are enhanced to include “waveform-cri-RI-PMI-CQI” or “waveform-cri-RI-i1” or “waveform-cri-RI-i1-CQI” or “waveform-cri-RI-CQI” or “waveform-cri-RSRP” or “waveform-ssb-Index-RSRP” or “waveform-cri-RI-L1-PMI-CQI” or some other combination.

According to a second embodiment directed to waveform associated beam/radio link failure detection and recovery enhancements, when multiple waveforms are supported for DL and/or UL, the beam failure detection can be enhanced to associate beam failure instance and corresponding beam failure detection with a waveform type. Basically, detection of beam failure on one waveform does not necessarily mean the beam failure is encountered for multiple waveforms. In such an embodiment, different procedures on how the beam failure detection and recovery procedure can be enhanced when associating with different waveform types are described. The proposed enhancements provide an additional dimension to consider before beam failure procedure is initiated.

It is noted that the embodiments below are applicable for radio link failure detection and recovery as well, although the description entails only beam related procedures. It is further noted that the measurements can be performed on PDCCH DMRS, PDSCH DMRS, CSI-RS, SSB RS, PUSCH DMRS, SRS or some combination thereof.

According to one embodiment directed to multiple waveform-based beam failure detection, when the UE is configured with multiple waveforms for RS transmission and corresponding measurements/reporting, then beam failure instances are counted per waveform and beamFailureInstanceMaxCount is configured per waveform. Once the beamFailureInstanceMaxCount is reached for all the waveform types, then only beam failure is declared. The threshold for beam failure detection (“BFD”) RS measurement may also be configured specifically for each of the configured waveforms.

In one implementation, the BFIs are first counted in a sequential manner from one waveform to another, e.g., first the beams are measured corresponding to one waveform and once the maximum number of beam failure instances are reached for one waveform, then the beams are measured corresponding to the second waveform. Similarly, this continues for all the beams of all the configured waveforms. After the beam failure instances reach the maximum count corresponding to each one of the waveforms, then beam failure is declared.

In an alternate implementation, the BFIs are first counted across multiple waveforms and second on multiple beams, e.g., first the first beam associated with one waveform is measured and if BFI is incremented for the one waveform, then the first beam associated with second waveform is measured and if BFI is incremented for the second waveform, then again the second beam for one waveform is measured, and so on. After the BFIs reach the maximum count corresponding to each of the waveforms, then beam failure is declared.

In another implementation, one single BFI counter is configured that is common to multiple waveforms. The sequence of BFI counting can be configured in two ways: first counting on all beams of one waveform and moving to the next waveform; and second is counting on first beam of one waveform, moving to the first beam of the second waveform, then second beam of one waveform, second beam of the second waveform, and so on. However, the same counter is incremented regardless of how the counting sequence is configured and once the coming BFI reaches the maximum count, then beam failure is declared.

In another implementation, one single BFI counter is configured, wherein the counter is incremented by 1, when the beam measurement is below the threshold on all the configured waveforms. If the beam measurement is above the threshold on at least one of the waveforms, then the counter is not incremented. For example, beam 1 is measured for CP-OFDM and SC-FDE, and if the measurement is below the threshold for both waveforms, then the BFI counter is incremented by 1. If beam 1 measurement is below a threshold for CP-OFDM, but above the required threshold for SC-FDE, then the BFI counter is not incremented or vice-versa.

In some embodiments, when the beam measurements for a waveform approach the minimum required measurement threshold, then the UE can trigger a gNB to update/switch the waveform. In one implementation, the UE triggers the gNB to update the waveform when the beam measurement for a waveform on all the configured beams is below a threshold.

According to another embodiment directed to multiple waveform-based beam failure recovery enhancement, when multiple waveforms are configured for RS measurements/reporting, beam failure recovery is not triggered unless the beam failure is detected corresponding to all the configured waveforms, as described above.

In one implementation, if beam failure is declared on beams for one waveform, but not all, then the RACH procedure is not yet initiated and the BFR procedure is initiated only for the corresponding waveform. Only when BFD is declared on all waveforms, then the RACH procedure is initiated for BFR.

In some embodiments, a PHY layer BFD is configured/indicated to the network (without MAC involvement) when BFD is not encountered for all the configured waveforms. When BFD on the configured waveforms is encountered, then MAC indication is done.

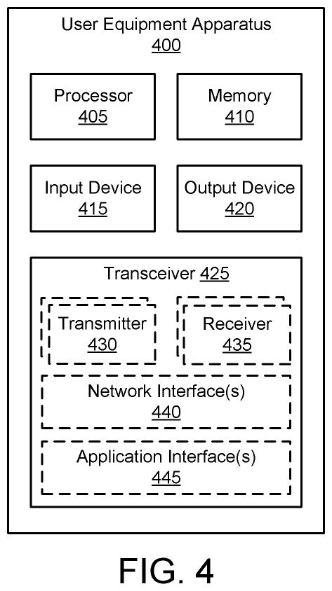

FIG. 4 depicts a user equipment apparatus 400 that may be used for configuration, measurement, and reporting for multiple waveform-based reference signals, according to embodiments of the disclosure. In various embodiments, the user equipment apparatus 400 is used to implement one or more of the solutions described above. The user equipment apparatus 400 may be one embodiment of a UE, such as the remote unit 105 and/or the UE 205, as described above. Furthermore, the user equipment apparatus 400 may include a processor 405, a memory 410, an input device 415, an output device 420, and a transceiver 425. In some embodiments, the input device 415 and the output device 420 are combined into a single device, such as a touchscreen. In certain embodiments, the user equipment apparatus 400 may not include any input device 415 and/or output device 420. In various embodiments, the user equipment apparatus 400 may include one or more of: the processor 405, the memory 410, and the transceiver 425, and may not include the input device 415 and/or the output device 420.

As depicted, the transceiver 425 includes at least one transmitter 430 and at least one receiver 435. Here, the transceiver 425 communicates with one or more base units 121. Additionally, the transceiver 425 may support at least one network interface 440 and/or application interface 445. The application interface(s) 445 may support one or more APIs. The network interface(s) 440 may support 3GPP reference points, such as Uu and PC5. Other network interfaces 440 may be supported, as understood by one of ordinary skill in the art.

The processor 405, in one embodiment, may include any known controller capable of executing computer-readable instructions and/or capable of performing logical operations. For example, the processor 405 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 405 executes instructions stored in the memory 410 to perform the methods and routines described herein. The processor 405 is communicatively coupled to the memory 410, the input device 415, the output device 420, and the transceiver 425. In certain embodiments, the processor 405 may include an application processor (also known as “main processor”) which manages application-domain and operating system (“OS”) functions and a baseband processor (also known as “baseband radio processor”) which manages radio functions.

The memory 410, in one embodiment, is a computer readable storage medium. In some embodiments, the memory 410 includes volatile computer storage media. For example, the memory 410 may include a RAM, including dynamic RAM (“DRAM”), synchronous dynamic RAM (“SDRAM”), and/or static RAM (“SRAM”). In some embodiments, the memory 410 includes non-volatile computer storage media. For example, the memory 410 may include a hard disk drive, a flash memory, or any other suitable non-volatile computer storage device. In some embodiments, the memory 410 includes both volatile and non-volatile computer storage media.

In some embodiments, the memory 410 stores data related to CSI enhancements for higher frequencies. For example, the memory 410 may store parameters, configurations, resource assignments, policies, and the like as described above. In certain embodiments, the memory 410 also stores program code and related data, such as an operating system or other controller algorithms operating on the user equipment apparatus 400, and one or more software applications.

The input device 415, in one embodiment, may include any known computer input device including a touch panel, a button, a keyboard, a stylus, a microphone, or the like. In some embodiments, the input device 415 may be integrated with the output device 420, for example, as a touchscreen or similar touch-sensitive display. In some embodiments, the input device 415 includes a touchscreen such that text may be input using a virtual keyboard displayed on the touchscreen and/or by handwriting on the touchscreen. In some embodiments, the input device 415 includes two or more different devices, such as a keyboard and a touch panel.

The output device 420, in one embodiment, is designed to output visual, audible, and/or haptic signals. In some embodiments, the output device 420 includes an electronically controllable display or display device capable of outputting visual data to a user. For example, the output device 420 may include, but is not limited to, an LCD display, an LED display, an OLED display, a projector, or similar display device capable of outputting images, text, or the like to a user. As another, non-limiting, example, the output device 420 may include a wearable display separate from, but communicatively coupled to, the rest of the user equipment apparatus 400, such as a smart watch, smart glasses, a heads-up display, or the like. Further, the output device 420 may be a component of a smart phone, a personal digital assistant, a television, a table computer, a notebook (laptop) computer, a personal computer, a vehicle dashboard, or the like.

In certain embodiments, the output device 420 includes one or more speakers for producing sound. For example, the output device 420 may produce an audible alert or notification (e.g., a beep or chime). In some embodiments, the output device 420 includes one or more haptic devices for producing vibrations, motion, or other haptic feedback. In some embodiments, all, or portions of the output device 420 may be integrated with the input device 415. For example, the input device 415 and output device 420 may form a touchscreen or similar touch-sensitive display. In other embodiments, the output device 420 may be located near the input device 415.

The transceiver 425 includes at least transmitter 430 and at least one receiver 435. The transceiver 425 may be used to provide UL communication signals to a base unit 121 and to receive DL communication signals from the base unit 121, as described herein. Similarly, the transceiver 425 may be used to transmit and receive SL signals (e.g., V2X communication), as described herein. Although only one transmitter 430 and one receiver 435 are illustrated, the user equipment apparatus 400 may have any suitable number of transmitters 430 and receivers 435. Further, the transmitter(s) 430 and the receiver(s) 435 may be any suitable type of transmitters and receivers. In one embodiment, the transceiver 425 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 425, transmitters 430, and receivers 435 may be implemented as physically separate components that access a shared hardware resource and/or software resource, such as for example, the network interface 440.

In various embodiments, one or more transmitters 430 and/or one or more receivers 435 may be implemented and/or integrated into a single hardware component, such as a multi-transceiver chip, a system-on-a-chip, an ASIC, or other type of hardware component. In certain embodiments, one or more transmitters 430 and/or one or more receivers 435 may be implemented and/or integrated into a multi-chip module. In some embodiments, other components such as the network interface 440 or other hardware components/circuits may be integrated with any number of transmitters 430 and/or receivers 435 into a single chip. In such embodiment, the transmitters 430 and receivers 435 may be logically configured as a transceiver 425 that uses one more common control signals or as modular transmitters 430 and receivers 435 implemented in the same hardware chip or in a multi-chip module.

In one embodiment, the processor 405 is configured to receive, via the transceiver 425, a first signaling information from a network, the first signaling information indicating a RS resource and a corresponding association to at least one waveform. In one embodiment, the processor 405 is configured to receive, via the transceiver 425, a second signaling information from the network, the second signaling information indicating a reporting configuration for performing measurements on the RS resource and the corresponding at least one waveform. In one embodiment, the processor 405 is configured to generate a measurement report according to the reporting configuration and transmit the measurement report to the network.

In one embodiment, the RS resource is at least one selected from the group of CSI-RS, SRS, DMRS, and SSB-RS.

In one embodiment, at least two RS resources are configured to the apparatus, the first resource associated with a first waveform and the second resource associated with a second waveform.

In one embodiment, the first waveform is a single carrier waveform and the second waveform is an OFDM-based multi-carrier waveform.

In one embodiment, the processor 405 is configured to perform measurements on the at least two RS resources associated with at least two different waveforms and transmit the measurement report to the network, the measurement report indicating at least one of two waveforms and corresponding measurements including RSRP, CQI, RI, LI, PMI, or some combination thereof.

In one embodiment, the RS resource is associated with a first and a second waveform type and corresponding RS structures, the RS resource transmitted a first time using the first waveform type and transmitted a second time using the second waveform type.

In one embodiment, the first waveform type is a single carrier waveform and the second waveform type is a orthogonal frequency division multiplexing (“OFDM”)-based multi-carrier waveform.

In one embodiment, the processor 405 is configured to perform two separate measurements on the RS resource transmitted the first time using the first waveform type and transmitted the second time using the second waveform type, and transmit the measurement report to the network, the measurement report indicating at least one of two waveforms and corresponding measurements including RSRP, CQI, RI, LI, PMI, or some combination thereof.

In one embodiment, the first signaling information is a semi-static RRC configuration.

In one embodiment, the processor 405 is configured to receive, via the transceiver 425, an indication of dynamic signaling information to update the waveform associated with the RS resource, wherein the updated waveform is different from the first waveform indicated by the first signaling information, the dynamic signaling information comprising a MAC CE, DCI, or a combination thereof.

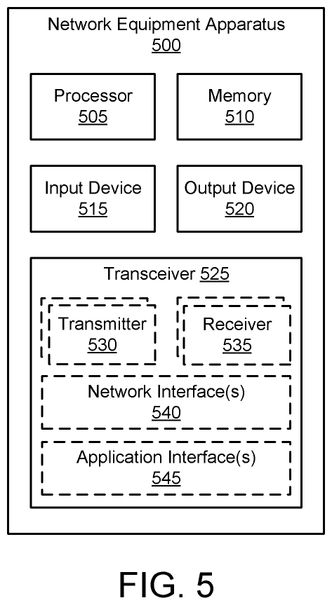

FIG. 5 depicts one embodiment of a network equipment apparatus 500 that may be used for configuration, measurement, and reporting for multiple waveform-based reference signals, according to embodiments of the disclosure. In some embodiments, the network apparatus 500 may be one embodiment of a RAN node and its supporting hardware, such as the base unit 121 and/or gNB, described above. Furthermore, network apparatus 500 may include a processor 505, a memory 510, an input device 515, an output device 520, and a transceiver 525. In certain embodiments, the network apparatus 500 does not include any input device 515 and/or output device 520.

As depicted, the transceiver 525 includes at least one transmitter 530 and at least one receiver 535. Here, the transceiver 525 communicates with one or more remote units 105. Additionally, the transceiver 525 may support at least one network interface 540 and/or application interface 545. The application interface(s) 545 may support one or more APIs. The network interface(s) 540 may support 3GPP reference points, such as Uu, N1, N2, N3, N5, N6 and/or N7 interfaces. Other network interfaces 540 may be supported, as understood by one of ordinary skill in the art.

The processor 505, in one embodiment, may include any known controller capable of executing computer-readable instructions and/or capable of performing logical operations. For example, the processor 505 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 505 executes instructions stored in the memory 510 to perform the methods and routines described herein. The processor 505 is communicatively coupled to the memory 510, the input device 515, the output device 520, and the transceiver 525. In certain embodiments, the processor 505 may include an application processor (also known as “main processor”) which manages application-domain and operating system (“OS”) functions and a baseband processor (also known as “baseband radio processor”) which manages radio function. In various embodiments, the processor 505 controls the network apparatus 500 to implement the above described network entity behaviors (e.g., of the gNB) for configuration, measurement, and reporting for multiple waveform-based reference signals.

The memory 510, in one embodiment, is a computer readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media.

In some embodiments, the memory 510 stores data relating to CSI enhancements for higher frequencies. For example, the memory 510 may store parameters, configurations, resource assignments, policies, and the like as described above. In certain embodiments, the memory 510 also stores program code and related data, such as an operating system (“OS”) or other controller algorithms operating on the network apparatus 500, and one or more software applications.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, may include any known electronically controllable display or display device. The output device 520 may be designed to output visual, audible, and/or haptic signals. In some embodiments, the output device 520 includes an electronic display capable of outputting visual data to a user. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all, or portions of the output device 520 may be integrated with the input device 515. For example, the input device 515 and output device 520 may form a touchscreen or similar touch-sensitive display. In other embodiments, all, or portions of the output device 520 may be located near the input device 515.

As discussed above, the transceiver 525 may communicate with one or more remote units and/or with one or more interworking functions that provide access to one or more PLMNs. The transceiver 525 may also communicate with one or more network functions (e.g., in the mobile core network 80). The transceiver 525 operates under the control of the processor 505 to transmit messages, data, and other signals and also to receive messages, data, and other signals. For example, the processor 505 may selectively activate the transceiver (or portions thereof) at particular times in order to send and receive messages.

The transceiver 525 may include one or more transmitters 530 and one or more receivers 535. In certain embodiments, the one or more transmitters 530 and/or the one or more receivers 535 may share transceiver hardware and/or circuitry. For example, the one or more transmitters 530 and/or the one or more receivers 535 may share antenna(s), antenna tuner(s), amplifier(s), filter(s), oscillator(s), mixer(s), modulator/demodulator(s), power supply, and the like. In one embodiment, the transceiver 525 implements multiple logical transceivers using different communication protocols or protocol stacks, while using common physical hardware.

In one embodiment, the processor 505 is configured to transmit, via the transceiver 525, a first signaling information to a UE, the first signaling information indicating a RS resource and a corresponding association to at least one waveform. In one embodiment, the processor 505 is configured to transmit, via the transceiver 525, a second signaling information to the UE, the second signaling information indicating a reporting configuration for performing measurements on the RS resource and the corresponding at least one waveform. In one embodiment, the processor 505 is configured to receive, from the UE, via the transceiver 525, a measurement report generated according to the reporting configuration.

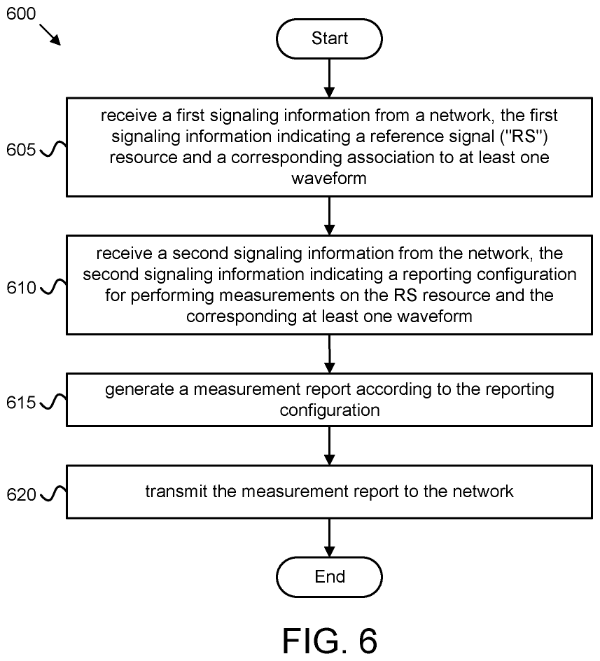

FIG. 6 is a flowchart diagram of a method 600 for configuration, measurement, and reporting for multiple waveform-based reference signals. The method 600 may be performed by a UE as described herein, for example, the remote unit 105 and/or the user equipment apparatus 400. In some embodiments, the method 600 may be performed by a processor executing program code, for example, a microcontroller, a microprocessor, a CPU, a GPU, an auxiliary processing unit, a FPGA, or the like.

In one embodiment, the method 600 begins and receives 605 a first signaling information from a network, the first signaling information indicating a RS resource and a corresponding association to at least one waveform. In one embodiment, the method 600 receives 610 a second signaling information from the network, the second signaling information indicating a reporting configuration for performing measurements on the RS resource and the corresponding at least one waveform. In one embodiment, the method 600 generates 615 a measurement report according to the reporting configuration. In one embodiment, the method 600 transmits 620 the measurement report to the network, and the method 600 ends.

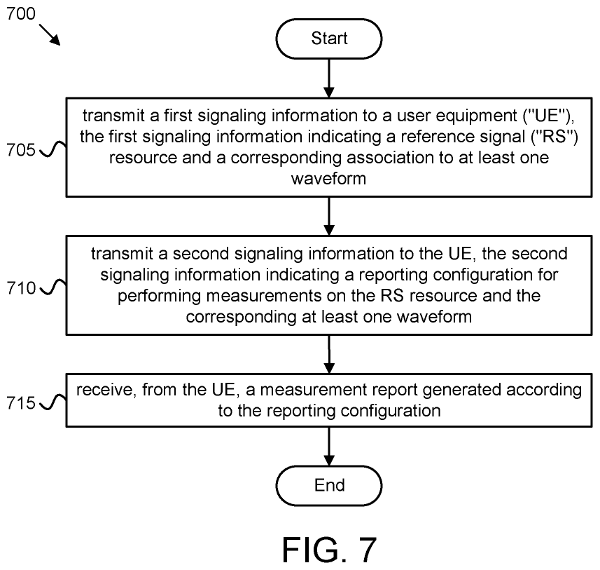

FIG. 7 is a flowchart diagram of a method 700 for configuration, measurement, and reporting for multiple waveform-based reference signals. The method 700 may be performed by a network device as described herein, for example, the gNB, base unit 121, and/or the network equipment apparatus 500. In some embodiments, the method 700 may be performed by a processor executing program code, for example, a microcontroller, a microprocessor, a CPU, a GPU, an auxiliary processing unit, a FPGA, or the like.

In one embodiment, the method 700 begins and transmits 705 a first signaling information to a UE, the first signaling information indicating a RS resource and a corresponding association to at least one waveform. In one embodiment, the method transmits 710 a second signaling information to the UE, the second signaling information indicating a reporting configuration for performing measurements on the RS resource and the corresponding at least one waveform. In one embodiment, the method 700 receives 715, from the UE, a measurement report generated according to the reporting configuration, and the method 700 ends.

A first apparatus is disclosed for configuration, measurement, and reporting for multiple waveform-based reference signals. The first apparatus may include a UE as described herein, for example, the remote unit 105 and/or the user equipment apparatus 400. In some embodiments, the first apparatus includes a processor executing program code, for example, a microcontroller, a microprocessor, a CPU, a GPU, an auxiliary processing unit, a FPGA, or the like

In one embodiment, the first apparatus includes a transceiver and a processor coupled to the transceiver. In one embodiment, the processor is configured to cause the apparatus to receive a first signaling information from a network, the first signaling information indicating a RS resource and a corresponding association to at least one waveform. In one embodiment, the processor is configured to cause the apparatus to receive a second signaling information from the network, the second signaling information indicating a reporting configuration for performing measurements on the RS resource and the corresponding at least one waveform. In one embodiment, the processor is configured to cause the apparatus to generate a measurement report according to the reporting configuration and transmit the measurement report to the network.

In one embodiment, the RS resource is at least one selected from the group of CSI-RS, SRS, DMRS, and SSB-RS.

In one embodiment, at least two RS resources are configured to the apparatus, the first resource associated with a first waveform and the second resource associated with a second waveform.

In one embodiment, the first waveform is a single carrier waveform and the second waveform is an OFDM-based multi-carrier waveform.

In one embodiment, the processor is configured to cause the apparatus to perform measurements on the at least two RS resources associated with at least two different waveforms and transmit the measurement report to the network, the measurement report indicating at least one of two waveforms and corresponding measurements including RSRP, CQI, RI, LI, PMI, or some combination thereof.

In one embodiment, the RS resource is associated with a first and a second waveform type and corresponding RS structures, the RS resource transmitted a first time using the first waveform type and transmitted a second time using the second waveform type.

In one embodiment, the first waveform type is a single carrier waveform and the second waveform type is a orthogonal frequency division multiplexing (“OFDM”)-based multi-carrier waveform.

In one embodiment, the processor is configured to cause the apparatus to perform two separate measurements on the RS resource transmitted the first time using the first waveform type and transmitted the second time using the second waveform type, and transmit the measurement report to the network, the measurement report indicating at least one of two waveforms and corresponding measurements including RSRP, CQI, RI, LI, PMI, or some combination thereof.

In one embodiment, the first signaling information is a semi-static RRC configuration.

In one embodiment, the processor is configured to cause the apparatus to receive an indication of dynamic signaling information to update the waveform associated with the RS resource, wherein the updated waveform is different from the first waveform indicated by the first signaling information, the dynamic signaling information comprising a MAC CE, DCI, or a combination thereof.

A first method is disclosed for configuration, measurement, and reporting for multiple waveform-based reference signals. The first method may be performed by a UE as described herein, for example, the remote unit 105 and/or the user equipment apparatus 400. In some embodiments, the first method may be performed by a processor executing program code, for example, a microcontroller, a microprocessor, a CPU, a GPU, an auxiliary processing unit, a FPGA, or the like.

In one embodiment, the first method receives a first signaling information from a network, the first signaling information indicating a RS resource and a corresponding association to at least one waveform. In one embodiment, the first method receives a second signaling information from the network, the second signaling information indicating a reporting configuration for performing measurements on the RS resource and the corresponding at least one waveform. In one embodiment, the first method generates a measurement report according to the reporting configuration and transmits the measurement report to the network.

In one embodiment, the RS resource is at least one selected from the group of CSI-RS, SRS, DMRS, and SSB-RS.

In one embodiment, at least two RS resources are configured to the apparatus, the first resource associated with a first waveform and the second resource associated with a second waveform.

In one embodiment, the first waveform is a single carrier waveform and the second waveform is an OFDM-based multi-carrier waveform.

In one embodiment, the first method performs measurements on the at least two RS resources associated with at least two different waveforms and transmit the measurement report to the network, the measurement report indicating at least one of two waveforms and corresponding measurements including RSRP, CQI, RI, LI, PMI, or some combination thereof.

In one embodiment, the RS resource is associated with a first and a second waveform type and corresponding RS structures, the RS resource transmitted a first time using the first waveform type and transmitted a second time using the second waveform type.

In one embodiment, the first waveform type is a single carrier waveform and the second waveform type is a orthogonal frequency division multiplexing (“OFDM”)-based multi-carrier waveform.

In one embodiment, the first method performs two separate measurements on the RS resource transmitted the first time using the first waveform type and transmitted the second time using the second waveform type, and transmit the measurement report to the network, the measurement report indicating at least one of two waveforms and corresponding measurements including RSRP, CQI, RI, LI, PMI, or some combination thereof.

In one embodiment, the first signaling information is a semi-static RRC configuration.

In one embodiment, the first method receives an indication of dynamic signaling information to update the waveform associated with the RS resource, wherein the updated waveform is different from the first waveform indicated by the first signaling information, the dynamic signaling information comprising a MAC CE, DCI, or a combination thereof.

A second apparatus is disclosed for configuration, measurement, and reporting for multiple waveform-based reference signals. The second apparatus may include a network device as described herein, for example, the gNB, base unit 121, and/or the network equipment apparatus 500. In some embodiments, the second apparatus includes a processor executing program code, for example, a microcontroller, a microprocessor, a CPU, a GPU, an auxiliary processing unit, a FPGA, or the like.

In one embodiment, the second apparatus includes a transceiver and a processor coupled to the transceiver. In one embodiment, the processor is configured to cause the apparatus to transmit a first signaling information to a UE, the first signaling information indicating a RS resource and a corresponding association to at least one waveform. In one embodiment, the processor is configured to cause the apparatus to transmit a second signaling information to the UE, the second signaling information indicating a reporting configuration for performing measurements on the RS resource and the corresponding at least one waveform. In one embodiment, the processor is configured to cause the apparatus to receive, from the UE, a measurement report generated according to the reporting configuration.

A second method is disclosed for configuration, measurement, and reporting for multiple waveform-based reference signals. The second method may be performed by a network device as described herein, for example, the gNB, base unit 121, and/or the network equipment apparatus 500. In some embodiments, the second method may be performed by a processor executing program code, for example, a microcontroller, a microprocessor, a CPU, a GPU, an auxiliary processing unit, a FPGA, or the like.

In one embodiment, the second method transmits a first signaling information to a UE, the first signaling information indicating a RS resource and a corresponding association to at least one waveform. In one embodiment, the second method transmits a second signaling information to the UE, the second signaling information indicating a reporting configuration for performing measurements on the RS resource and the corresponding at least one waveform. In one embodiment, the second method receives, from the UE, a measurement report generated according to the reporting configuration.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (“UE”) apparatus, comprising:
a transceiver; and
a processor coupled to the transceiver, the processor configured to cause the apparatus to:
receive a first signaling information from a network, the first signaling information indicating a reference signal (“RS”) resource and a corresponding association to at least one waveform;
receive a second signaling information from the network, the second signaling information indicating a reporting configuration for performing measurements on the RS resource and the corresponding at least one waveform;
generate a measurement report according to the reporting configuration; and
transmit the measurement report to the network.

2. The apparatus of claim 1, wherein the RS resource is at least one selected from the group of channel state information reference signal (“CSI-RS”), sounding reference signal (“SRS”), demodulation reference signal (“DMRS”) and synchronization signal block reference signal (“SSB-RS”).

3. The apparatus of claim 1, wherein at least two RS resources are configured to the apparatus, the first resource associated with a first waveform and the second resource associated with a second waveform.

4. The apparatus of claim 3, wherein the first waveform is a single carrier waveform and the second waveform is an orthogonal frequency division multiplexing (“OFDM”)-based multi-carrier waveform.

5. The apparatus of claim 3, wherein the processor is configured to cause the apparatus to perform measurements on the at least two RS resources associated with at least two different waveforms and transmit the measurement report to the network, the measurement report indicating at least one of two waveforms and corresponding measurements including reference signal received power (“RSRP”), channel quality indicator (“CQI”), rank indicator (“RI”), layer indicator (“LI”), precoding matrix indicator (“PMI”), or some combination thereof.

6. The apparatus of claim 1, wherein the RS resource is associated with a first and a second waveform type and corresponding RS structures, the RS resource transmitted a first time using the first waveform type and transmitted a second time using the second waveform type.

7. The apparatus of claim 6, wherein the first waveform type is a single carrier waveform and the second waveform type is a orthogonal frequency division multiplexing (“OFDM”)-based multi-carrier waveform.

8. The apparatus of claim 7, wherein the processor is configured to cause the apparatus to perform two separate measurements on the RS resource transmitted the first time using the first waveform type and transmitted the second time using the second waveform type, and transmit the measurement report to the network, the measurement report indicating at least one of two waveforms and corresponding measurements including reference signal received power (“RSRP”), channel quality indicator (“CQI”), rank indicator (“RI”), layer indicator (“LI”), precoding matrix indicator (“PMI”), or some combination thereof.

9. The apparatus of claim 1, wherein the first signaling information is a semi-static radio resource control (“RRC”) configuration.

10. The apparatus of claim 9, wherein the processor is configured to cause the apparatus to receive an indication of dynamic signaling information to update the waveform associated with the RS resource, wherein the updated waveform is different from the first waveform indicated by the first signaling information, the dynamic signaling information comprising a medium access control control element (“MAC CE”), downlink control information (“DCI”), or a combination thereof.

11. A method of a user equipment (“UE”) apparatus, comprising:
receiving a first signaling information from a network, the first signaling information indicating a reference signal (“RS”) resource and a corresponding association to at least one waveform;
receiving a second signaling information from the network, the second signaling information indicating a reporting configuration for performing measurements on the RS resource and the corresponding at least one waveform;
generating a measurement report according to the reporting configuration; and
transmitting the measurement report to the network.

12. The method of claim 11, wherein the RS resource is at least one selected from the group of channel state information reference signal (“CSI-RS”), sounding reference signal (“SRS”), demodulation reference signal (“DMRS”) and synchronization signal block reference signal (“SSB-RS”).

13. The method of claim 11, wherein at least two RS resources are configured to the apparatus, the first resource associated with a first waveform and the second resource associated with a second waveform.

14. The method of claim 13, wherein the first waveform is a single carrier waveform and the second waveform is an orthogonal frequency division multiplexing (“OFDM”)-based multi-carrier waveform.

15. A network entity apparatus, comprising:
a transceiver; and
a processor coupled to the transceiver, the processor configured to cause the apparatus to:
transmit a first signaling information to a user equipment (“UE”), the first signaling information indicating a reference signal (“RS”) resource and a corresponding association to at least one waveform;
transmit a second signaling information to the UE, the second signaling information indicating a reporting configuration for performing measurements on the RS resource and the corresponding at least one waveform; and
receive, from the UE, a measurement report generated according to the reporting configuration.
